(19) United States
(12) Patent Application Publication
(10) Pub. No.: US 2005/0034465 A1
(43) Pub. Date: Feb. 17, 2005

(54) Cryopump control system

(76) Inventors: John Borchers, Allentown, PA (US); Gary Ash, Dartmouth, MA (US); Ralph C. Longsworth, Allentown, PA (US); Jin Lin Gao, Allentown, PA (US); Masamichi Ando, Saitama (JP)

Correspondence Address: KATTEN MUCHIN ZAVIS ROSENMAN, 575 MADISON AVENUE, NEW YORK, NY, 10022-2585, US

(21) Appl. No.: 10/901,902

(22) Filed: Jul. 29, 2004

Related U.S. Application Data
(60) Provisional application No. 60/490,772, filed on Jul. 29, 2003.

(51) Int. Cl. B01D 8/00

(52) U.S. Cl. 62/55.5

(57) ABSTRACT

A cryopump control system with single or multiple cryopumps is controlled by a parallel system operating modules connected by two low voltage wires. A separate cable is also connected to the operating module to provide power to various cryopump components. Communication is via a bus that communicates directly with IC devices in the operating modules that also contain small capacitors to enable the control system to be run by a single computer processor in which all of the logic for controlling one or more cryopumps and communicating with additional optional components resides.

### BACKGROUND OF THE INVENTION

This invention relates to a system for controlling the operation of one or more cryopumps and other optional components which are part of a vacuum system such as a semiconductor wafer processing system.

Cryopumps generally employ two-stage cryogenic expanders that operate on the Gifford McMahon, GM, cycle, which uses a separate compressor to compress the working fluid, helium. Cryopanels mounted on the first and second stages of the expander freeze out type 1 gases, such as water, on the first stage at 50 K to 90 K, freeze out type 2 gases, such as nitrogen, oxygen, and argon, on the second stage at 10 K to 20 K, and use an adsorbent, such as charcoal, bonded to the back of the second stage panel to adsorb type 3 gases, such as hydrogen, also at 10 K to 20 K. Because gases collect on the cryopanels it is necessary to periodically defrost the panels, a process known as regeneration. A cryopump controller generally is used to control the cooldown, operation, and regeneration, of one or more cryopumps and other optional components. Prior to starting a cryopump it is desirable to purge or evacuate the pump to remove contaminants, and imperative to evacuate the pump sufficiently for it to cooldown, e.g <10 Pa. A multi-pump system typically has a single mechanical pump, usually referred to as a roughing pump, to evacuate one or more pumps. An important function of the control system is to assure that only one pump at a time is connected to the roughing pump although there may be times when it is desirable to rough more than 1 pump at a time.

A system for controlling six large cryopumps on a vacuum system to test Global Positioning Satellites was described by Finley. The control logic, which is located in a central computer, provides automatic regeneration of each cryopump, and control of the evacuation such that only one cryopump at a time is connected to a common vacuum manifold. The control system has a table with the values of parameters that are used in the control process. This enables the operator to simply change the parameters without changing the control program. The operator has the ability to manually override the automatic control.

Brown et al. describe using microprocessor controllers at each of a multitude of vacuum systems for local control but connected to a central computer for overall control.

Bachler et al. describe a typical cryopump with a two-stage GM refrigerator that is instrumented for automatic control. It includes a programmable control unit capable of putting out controlling signals on the basis of signals from sensors mounted on the cryopump. Sensors and components that are described include temperature sensors and electrical heaters on each stage of the refrigerator with an electrical feed-through, a vacuum pressure gauge, purge gas and a solenoid valve to control it, a vacuum pumpout port with a valve to control access to the rough pump, a valve to allow gases to vent to atmospheric pressure, a gas bottle and valves to admit a small quantity of gas such as Ar, or N2 to dilute an explosive mixture, and a gate valve between the cryopump housing and the main vacuum chamber. Procedures are described for using the sensors and heaters in conjunction with the controller to control the initial cooldown of the cryopump, do a partial regeneration to remove type 2 and 3 gases, and to do a full regeneration to remove all gases.

Gaudet et al. describe a multi-pump system with programmable controllers that are integrally mounted to each cryopump. Each pump-mounted controller contains a microprocessor and stored program memory. These automatically control each cryopump in response to signals from sensors on the cryopumps, commands that are entered at the individual controller, or commands received from a central computer terminal. Data and commands are communicated via an RS-232 line between the central computer and the cryopump controllers, which are connected in a “daisy chain” fashion. A “token” is passed from one pump to the next during regeneration to limit access to a common roughing line to one cryopump at a time. In practice the central computer typically consists of a network terminal which is connect to the host computer by an RS-232 line. The host computer typically controls the entire semiconductor wafer processing machine and sends high level instructions to the network terminal to turn specific pumps on/off, start regeneration, etc. It receives data from the network terminal advising of the status of individual pumps such as cooling down, cold, running normally, fault condition, etc.

Noji et al. claim to get faster communication with individual cryopump controllers by connecting them in parallel to a network controller rather than in a serial “daisy chain” fashion. The network controller is connected by RS-232 cables to the host computer and to the individual cryopump controllers. The cryopump is assumed to be a two-stage GM type pump that may incorporate temperature sensors, heaters, a purge valve, a roughing valve, a vent valve, a gate valve, and a variable speed expander drive motor. Power for the devices that need it is supplied from a cable that is separate from the RS-232 cable. Most of the logic functions for controlling the cryopump reside in the cryopump controller. The control concept includes the ability to have the network controller control a mix of different types of pumps, such as turbomolecular pumps, turbo-cryopumps, cryopumps, etc.

Morishita et al. describe a control system for multiple two-stage GM type cryopumps that has a central processor connected to a host computer via an RS-232 cable and to each of multiple cryopump controllers through a communication network. The logic for controlling the individual cryopumps resides in the central processor. The communication network is described as typically being a LAN (Local Area Network) which is a bus that connects all of the communication conversion sections in parallel. Information is put on the bus in packets, with a header that has an address for the intended cryopump. The communication from the central processor to the cryopump communication conversion section would typically be a command or a request for data. The cryopump communication conversion section has an Input/Output, I/O, section that converts the signal packet from the central processor to a format that can be read by a specific control component, or converts data from the cryopump communication conversion section to a packet in the format that can be put on the LAN. A separate power line to the cryopump communication conversion section provides power for the valve motor, solenoid valves, heaters, etc.

The present invention improves upon previous control systems by simplifying the wiring and reducing the number of circuits in the control system. This is accomplished in large part by the use of 1-Wire®technology as described in U.S. Pat. Nos. 5,832,207 and 6,219,789, the disclosure of which is incorporated herein by reference. IC devices that incorporate 1-Wire® technology are produced by Dallas Semiconductor Corp. Earlier versions of this type technology that use two active wires can also be used.

The system that is described is applicable to different types of vacuum pumps and other system components; however the primary example is for a system in which the vacuum pumps are cryopumps and the other principal system component is one or more compressors that supply gas to the cryopumps.

### SUMMARY OF THE INVENTION

A cryopump control system with single or multiple cryopumps is run by a parallel 1-Wire® network. This enables the cryopump control system to be run by a central control computer, e.g. a single computer processor. All of the logic for controlling one or more cryopumps and communicating with additional optional components resides in the central control computer. Each individual cryopump in the system has an operating module attached to it that contains IC devices which send data to, or receive instructions from, the central control computer. Communication between the central control computer, the operating modules, and optional additional components such as the system compressor(s), is via a bus that communicates directly with each IC device. The 1-Wire® technology consists of two wires, a ground wire and a 2.8-6.0 volt signal wire. The 1-Wire® IC devices that are used in the operating modules contain small capacitors so they can get their power from the data wire and continue to operate during the brief periods of time when the data communication drops the voltage to 0. The operating module thus has only two low voltage wires for the control functions. A separate cable is also connected to the operating module to provide power to various cryopump components

It is the object of the present invention to provide a vacuum pump control system, which is capable of controlling several vacuum pumps and associated system components from one central control computer. Such central control computer may use a common stored program for each of the pumps on the system or may use unique program elements for individual pumps. The central control computer functions may be incorporated in the host computer processor or may reside in a separate central control computer that communicates with the host computer

It is another object of this invention to create an electronic operating module for an individual vacuum pump, which does not include a microprocessor or stored program. This reduces the complexity, size, and manufacturing cost of each operating module. Significantly, it also enables rapid and simple means of altering or upgrading the control algorithms used in the system by modifying only the stored program in the control computer.

It is another object of this invention to provide a means of connecting the data ports of each pump to the single data port of the computer by either parallel or serial means or both. This allows flexibility in the routing of wiring, economy, and redundancy.

### BRIEF DESCRIPTION OF THE DRAWINGS

FIG. 1 is a block diagram of system 21 showing the interconnection of the host computer, control computer, driver, interconnecting data lines to the operating modules for the vacuum pumps and compressors, as well as the vacuum pumps, compressors, and vacuum chambers.

FIG. 2 is a block diagram of system 22 showing the interconnection of the host computer, control computer, driver, interconnecting data lines to the operating modules for the vacuum pumps and compressors with several hubs, as well as the vacuum pumps, compressors, and vacuum chambers.

FIG. 3 is a block diagram of system 23 showing the interconnection of the host computer, control computer, two drivers, interconnecting data lines to the operating modules for the vacuum pumps and compressors with hubs, as well as the vacuum pumps, compressors, and vacuum chambers.

FIG. 4 is a block diagram of system 24 showing the interconnection of the host computer, control computer, driver, interconnecting data lines to the operating modules for the vacuum pumps and compressors with a hub having multiplexers, as well as the vacuum pumps, compressors, and vacuum chambers.

FIGS. 5a and 5b represent the interconnections among the operarting modules and system components

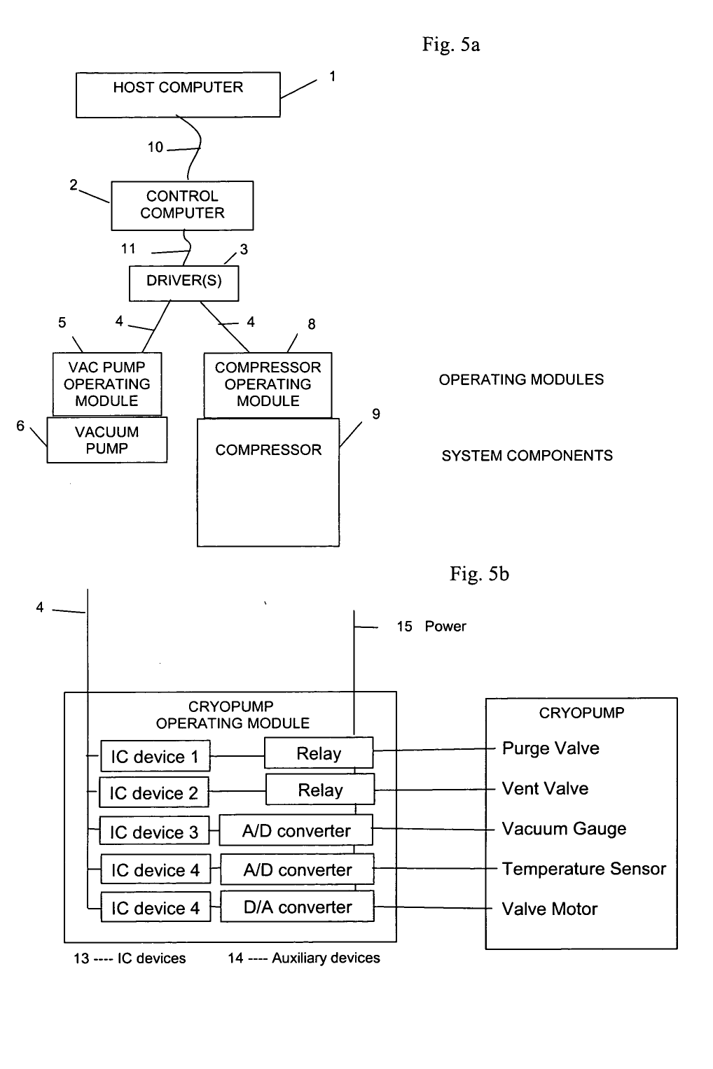

### DESCRIPTION OF THE INVENTION

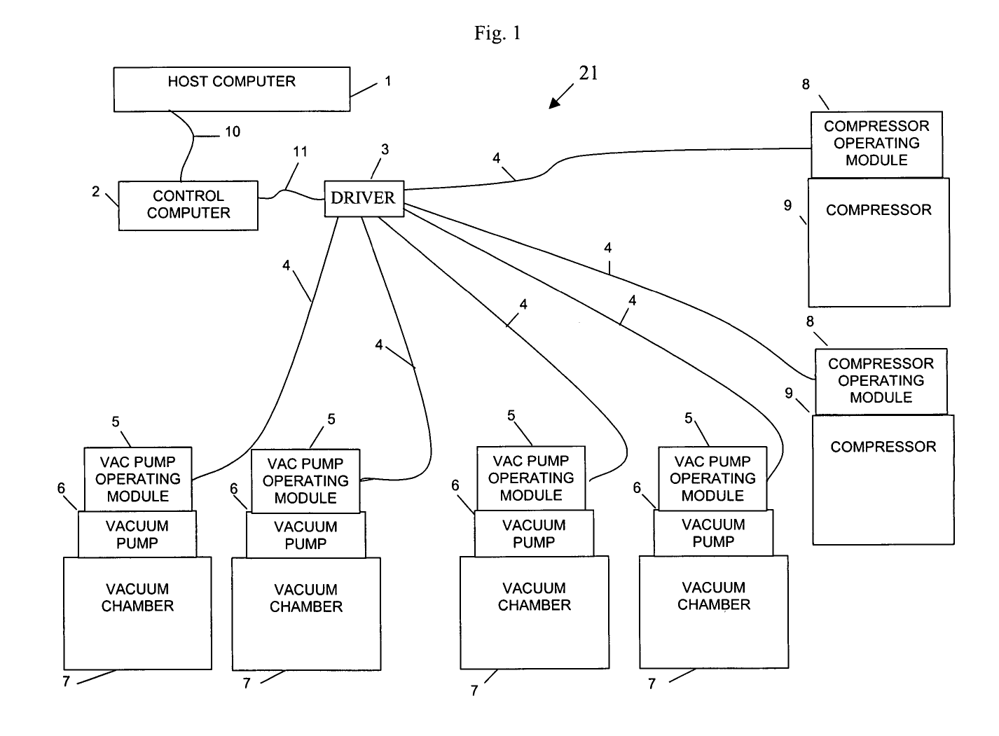

FIG. 1 shows the general layout of a typical vacuum system 21, with multiple vacuum chambers 7, and vacuum pumps 6. The vacuum pumps are typically cryopumps that employ two-stage GM expanders to cool cryopanels on each stage. He gas supplied by one or more compressors 9 is supplied to the expanders to produce refrigeration. Patents by Noji et al. and Morishita et al. show examples of cryopumps that include accessory instrumentation and components that are used to control cooldown, cold operation, regeneration, and the response to upset conditions. The vacuum pumps could alternately be another type of pump, such as a turbomolecular pump.

To control the overall vacuum system, material handling, and processes, the system typically employs a host computer 1. This may use any of the existing technologies and operating systems. A control computer 2 is provided as part of the described invention to control the various vacuum pumps and compressors. The control computer runs the software, which manages the functions of the vacuum pumps. Typically, the host computer 1 is connected to the control computer via a data line 10 which may use RS-232 protocol or any other applicable protocol. In turn, the control computer is connected to a driver 3 via another data line 11 which may be RS-232 or any other protocol. The driver converts the protocol used at the computer level to the protocol embodied in the cryopump operating module 5 and the compressor operating module 8.

The control computer 2 functions may be incorporated in the host computer 1 processor or may reside in a separate control computer 2 that communicates with the host computer 1, as shown in FIG. 1.

Between the driver and any operating module, such as compressor operating module 8, or modules of other functions, a data bus is constructed. The operating modules 5 and 8 use a protocol developed by Dallas Semiconductor Corporation, Dallas, Tex., for their 1-Wire® product line of IC semiconductor devices. In the literal sense, only one wire is required to both send data and power the device, plus a common ground. In practice, this is implemented on distributed systems through the use of a twisted pair of wires to carry the data wire and common ground wire. Devices in the 1-Wire® family include switches, potentiometers, temperature sensors, analog-to-digital (A/D) converters, timers, and memory. Each device has a unique 64-bit serial number which serves as an address code and which can be used to identify the function of the device.

Significantly, none of these devices has general computing capability. A command consisting of a string of pulses created by changing the voltage level of the input line from high (2.8-6.0 Volts) to low (2.3-0 Volts) and back is sent to the device. The device then performs an action (example: opens its switch) or returns a coded value (voltage sensed by A/D converter). All devices take actions sent by the external commands.

All of the 1-Wire devices are attached to the same data line 4. It may be divided into multiple segments but all of the segments carry the same packets of data. In this case, the input may be referred to as a “bus” with all devices on-line all of the time. FIG. 1 shows separate lines, 4, from each cryopump operating module 5 and compressor operating module 8 to driver 3. All devices decode the addresses included on commands entered on the bus. Any individual device only takes action if the command has its unique address. A list or map of the devices is created in the software of the control computer 2 to track which commands get sent to which device. The control computer 2 software also tracks which devices are located in the various modules. The driver 3 is reset before each data packet is sent and waits for a response before being reset and sending a new data packet.

Each cryopump operating module 5 and compressor operating module 8 may have an eprom IC device on it that has a list of the addresses and functions of each of the IC IC devices in the module. This facilitates having the control computer 2 obtain the address, function, and location, information that is needed by the main program. In particular it facilitates the replacement of one operating module with another for service purposes.

Although the system and method are described in terms of a 1-Wire type control other control types are available that use an earlier design that has two active wires plus a ground. The older technology has separate wires, one for serial data, SDA, and a second for serial clock timing, SCL. For example, Philips Semiconductors produces I²C-bus™ IC devices for the operating modules that act directly from the signals sent via wires 4 by driver 3. Both the SDA and SCL wires are at a nominal 5 volts. Some IC devices also receive power from a separate input.

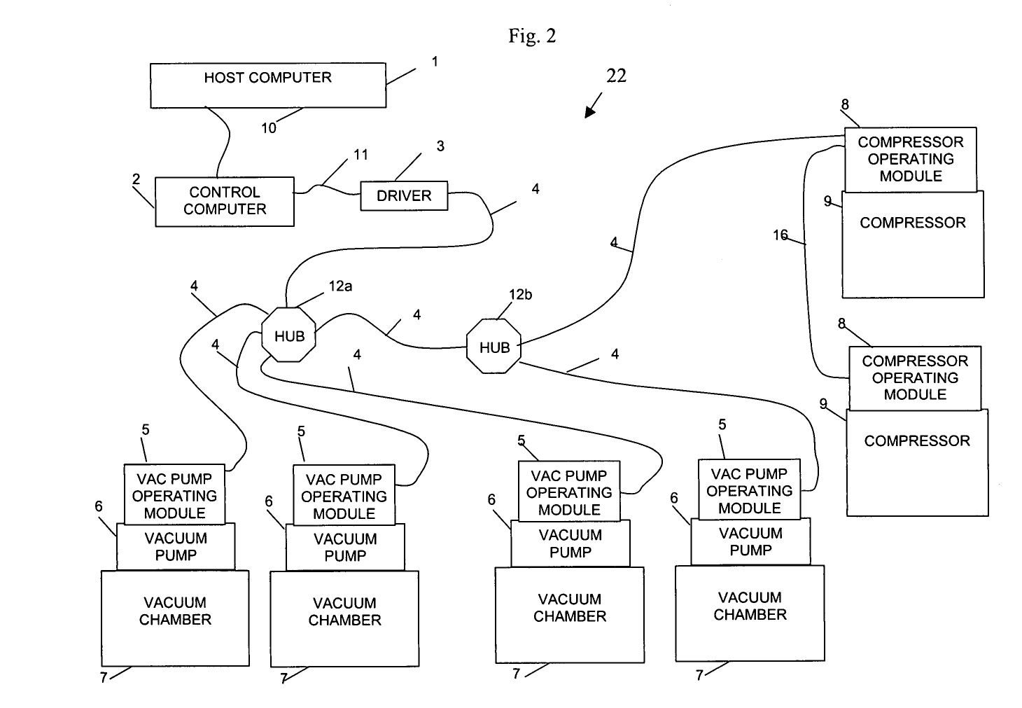

FIG. 2 shows a system 22 similar to system 21 except the data line is connected to one or more hubs, 12a and 12b. Because of the way that the commands are structured and addressed to the IC devices, all of the IC devices in an entire system are essentially connected in a parallel fashion to the driver and control computer. Any method of connecting the driver to an operating module produces the desired effect. That is, the driver may be connected to a passive, multiport hub 12a via a twisted wire pair. The hub serves to branch the data wire and common wire to as many ports as needed at that point. There is essentially no limit to the fan-out number achieved at any hub. For example, a 12-port hub allows for one input port and 11 output ports. Any one the passive ports may be used as the input. From the hub 12a, other data lines 4 may go to individual operating modules 5 and 8 or another hub 12b.

Another example of usable wiring schemes is shown in the connection from hub 12b to compressor operating module 8 via data line 4. The compressor operating module (or any function module) may include a pair of identical connectors wired in loop-through fashion. That is, both connectors have their common ground terminals connected together and the data input lines connected together. The data input line of the connectors is also attached to the devices within the compressor operating module 8. Thus, another data line 16 can be used to link a second compressor operating module to the common data bus via the loop-through connector, just as if this data line 16 had joined the hub 12b with the second compressor operating module. In effect, line 16 is an extension of line 4.

It should also be clear that for redundancy purposes, provision of a loop-through connector enables a data line to come from two sources, such as two hubs. Similarly, a hub may be fed via two or more parallel paths. Commonly, the total distance of any active 1-Wire device from the driver 3 may be up to 200 meters using passive hubs. The use of active repeaters can extend the range if necessary.

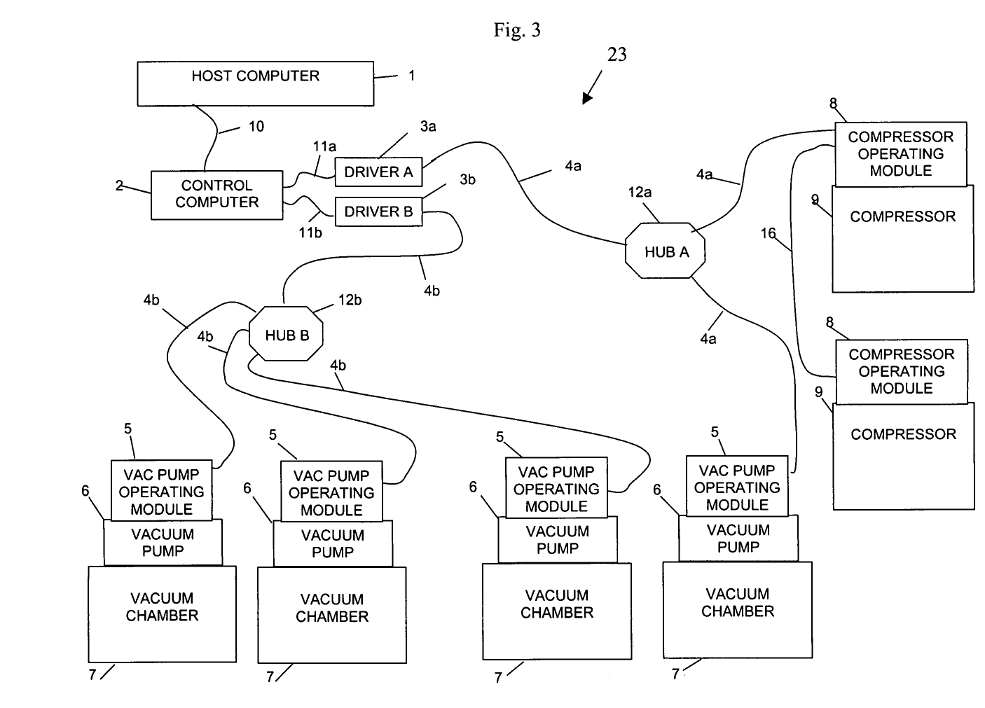

While the 1-Wire system has a high bandwidth capability, a single data line out of a driver ultimately may reach its limit in the number of devices that it can control efficiently. This is due to the capacitance of the line, which is a function of its total length. Reducing the data transmission rate can compensate for long lines. FIG. 3 shows system 23 which increases the speed of controlling multiple operating modules, 5 and 8, by dividing the system into more than one circuit, each with its own driver, 3a and 3b. Control computer 2 sends data packets to components on bus 4a through line 11a and driver 3a, and data packets to the components on bus 4b through line 11b and driver 3b. This not only reduces the length of the lines in each circuit but also enables one operating module on each bus to be communicating with control computer 2 simultaneously. The software of control computer 2 tracks which devices are addressed by the various ports.

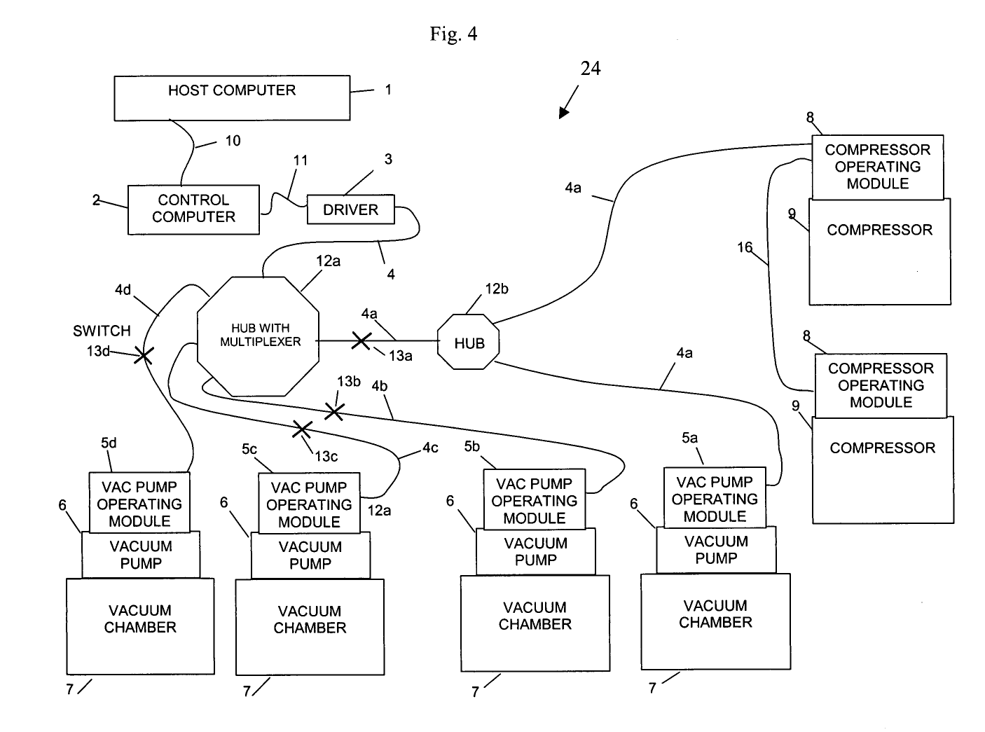

FIG. 4 shows another system, 24, that achieves higher speeds than are possible with systems 21 or 22, by adding a multiplexer to hub 12a. By putting a multiplex switch on each branch of line 4 from the hub, the data packet travels over a shorter length of line than if line 4 is common to all of the operating modules, 5 and 8. Each data packet has the address of the operating module, and the IC device in the operating module that is being addressed. Thus for example a data packet that is addressed to a IC device on cryopump operating module 5d is sent to multiplexer hub 12a via line 4. Multiplex switch 13d opens and sends it to cryopump operating module 5d through line 4d.

The IC devices in each operating module connect to auxiliary devices in the operating module that in turn connect to the system components they are controling. These auxiliary devices may include relays for actuating valves and heaters, A/D converters for sensor data, a power supply for the valve motor, etc. AC power of nominal 200-240 volt, 50/60 Hz is supplied to the cryopump operating module 5 from a power cord. Internal transformers and DC power supplies are used to convert the input voltage to the levels required for the auxiliary devices and the cryopump. This permits 24 VAC to be supplied to solenoid valves and to a power pin on an accessory relay connector.

Additionally, the operating module takes input from temperature sensors, switch closures, or transistor logic (typically 0-5V) inputs. Because the internal A/D converters of the operating module merely convert voltage to pulses, great flexibility is obtained in adding or changing functionality of the control module itself. By changing blocks of the software at the control computer level, different calibration or response curves for sensors can be easily accommodated, for example. The compressor operating module 8 has its own set of functions. It is used to monitor voltages from the compressor that represent supply and return pressure. Additionally, it monitors the state of several temperature switches. The compressor operating module draws its power from a “hot” pin on the multipin connector, which joins the compressor operating module to the compressor.

The particular schemes described in this invention have in practice been used for the control of cryogenic vacuum pumps and associated helium compressors. It should be clear to those skilled in the art that the use of such an operating module is not limited to cryogenic vacuum pumps but may also be applied to the control of turbomolecular vacuum pumps and other types of machinery.

1. A vacumn pump control system for controlling a plurality of system operating modules which in turn control system components, comprising:
a computer controller operating under a first protocol;
at least two system operating modules operating under a second protocol;
at least one system component connected to and in communication with each system operating module;
at least one driver that converts the first protocol of the computer controller to the second protocol of the system operating modules, wherein
the driver and system operating modules are connected by wires that carry control signals;
the operating modules have no computer functions, and
the system components respond to signals from the system operating modules.

2. The control system of claim 1 wherein the system components are selected from a vacumn pump and a compressor.

3. The control system of claim 1 wherein at least one of the system components is a vacumn pump.

4. The control system according to claim 3, wherein the vacuum pump is selected from the group consisting of a cryopump, a turbomolecular pump, a dry pump, and a cryoturbo pump.

5. The control system according to claim 1, wherein there is at least one hub between the at least one driver and the at least one operating module.

6. The control system according to claim 5 in which the hub has multiplexers.

7. The control system according to claim 1, wherein the computer controller is connected to a host computer.

8. A method of controlling a plurality of system operating modules which in turn control cryopumps or other system components in a vacumn pump control system utilizing a central computer controller where the operating modules do not contain a general purpose microprocessor or stored program, comprising:
a computer controller operating under a first protocol;
at least two system operating modules operating under a second protocol;
at least one system component connected to and in communication with each system operating module;
at least one driver that coverts the first protocol of the computer controller to the second protocol of the system operating modules, wherein
the driver and system operating modules are connected by wires that carry control signals;
the operating modules have no computer functions,
where the program in the central computer controller signals the operating modules and the operating modules in response thereto cause a change in the system component associated with that operating module.

9. The method according to claim 8 for controlling multiple cryopumps and compressors through parallel connections, loop-through connections or both.

10. The method according to claim 9 for controlling multiple cryopumps and compressors through a parallel network of data connections.

11. The method according to claim 9 for controlling multiple cryopumps and compressors through loop-through connections.

12. The method of claim 8 where software-assignable functions are provided within a cryopump or compressor control circuit to permit alteration of the scale, range, and calibration of a sensor circuit.

13. The method of claim 8 where the vacumn pump is a turbomolecular vacuum pump.
